(19) United States
(12) Patent Application Publication
(10) Pub. No.: US 2010/0293768 A1
(43) Pub. Date: Nov. 25, 2010

(54) BROKEN HEART SHAPED VAULT

(76) Inventor: Antoine Elhaj, Sandusky, OH (US)

Correspondence Address: RONALD J. KOCH, 698 MORRISON RD., SUITE B, COLUMBUS, OH, 43213, US

(21) Appl. No.: 12/468,861

(22) Filed: May 19, 2009

(51) Int. Cl. A61G 17/00

(52) U.S. Cl. 27/35

(57) ABSTRACT

A vault having a rectangular cover, and a rectangular enclosure assembly having a rectangular bottom and a vertical side wall attached to the bottom essentially around the periphery thereof, a curved support base adapted to hold a heart shaped coffin, and four curved support members attached to the bottom and being adapted to support the curved support base vertically above the bottom.

### CROSS REFERENCE TO RELATED APPLICATIONS

application Ser. No. 12/390,400, filed Feb. 20, 2009; Ser. No. 12/430,882, filed Apr. 27, 2009

### FEDERALLY SPONSORED RESEARCH

Not Applicable

### SEQUENCE LISTING, TABLE, OR COMPUTER PROGRAM COMPACT DISK APPENDIX

Not Applicable

### CLAIM OF PRIORITY BASED ON COPENDING APPLICATION

claims benefit of utility application Ser. Nos. 12/390,400 & 12/430,882

The present application is related to the co-pending patent application Ser. No. 12/390,400 of Antoine Elhaj, filed Feb. 20, 2009, entitled “Broken Heart Shaped Coffin”; and Ser. No. 12/430,882 of Antoine Elhaj, filed Apr. 27, 2009, entitled “Broken Heart Shaped Coffin”, and based on which priority is herewith claimed under 35 U.S.C. 120 and the disclosures of which are incorporated herein by reference in its entirety as if fully rewritten herein.

### BACKGROUND AND SUMMARY

The present invention relates generally to vaults for coffins and specifically to vaults having unique shapes or capable of holding coffins of unique shapes. The terms casket and coffin as used herein are interchangeable.

One embodiment of an half heart shaped vault comprises a half heart shaped cover and a half heart shaped enclosure having a bottom and a vertical side wall that forms essentially a half heart shape whereby a heart shaped coffin (see U.S. application Ser. No. 12/390,400 of Antoine Elhaj, filed Feb. 20, 2009, entitled “Broken Heart Shaped Coffin”; and Ser. No. 12/430,882 of Antoine Elhaj, filed Apr. 27, 2009, entitled “Broken Heart Shaped Coffin”) can be placed therein.

Another embodiment (FIGS. 1 & 2) comprises a complementary pair of first and second half heart shaped vaults being mirror images of each other so that they can be buried in the ground to form a unitary heart shape.

One embodiment of a vault comprises, a rectangular cover, and a rectangular enclosure assembly having, a rectangular bottom and a vertical side wall attached to the bottom essentially around the periphery thereof, a curved support base adapted to hold a heart shaped coffin, and four curved support members attached to the bottom and being adapted to support the curved support base vertically above the bottom.

One of skill in the art would appreciate that other means are possible of vertically supporting the curved base member sufficient to hold a coffin (e.g. it could be attached directly to the side walls or rest upon posts).

### BRIEF DESCRIPTION OF THE DRAWINGS

FIG. 1 depicts a perspective view of one embodiment of complementary half heart shaped vaults

FIG. 2 depicts a top view of one embodiment of complementary half heart shaped vaults

FIG. 3 depicts a perspective exploded view of one embodiment of the half heart shaped vault

FIG. 4 depicts a side exploded view of one embodiment of the half heart shaped vault

FIG. 5 depicts a top view of one embodiment of the half heart shaped vault

FIG. 6 depicts a cross sectional view as depicted in FIG. 5

FIG. 7 depicts a perspective view of one embodiment of the half heart shaped vault

FIG. 8 depicts a perspective view of one embodiment of a rectangular vault having inner curved support means

FIG. 9 depicts a cross sectional view of one embodiment of a rectangular vault having inner curved support means

FIG. 10 depicts a partial perspective view of one embodiment of a rectangular vault having inner curved support means

FIG. 11 depicts a partial perspective view of one embodiment of a rectangular vault having inner curved support means and holding a half heart shaped coffin

FIG. 12 depicts a partial side view of one embodiment of a rectangular vault having inner curved support means

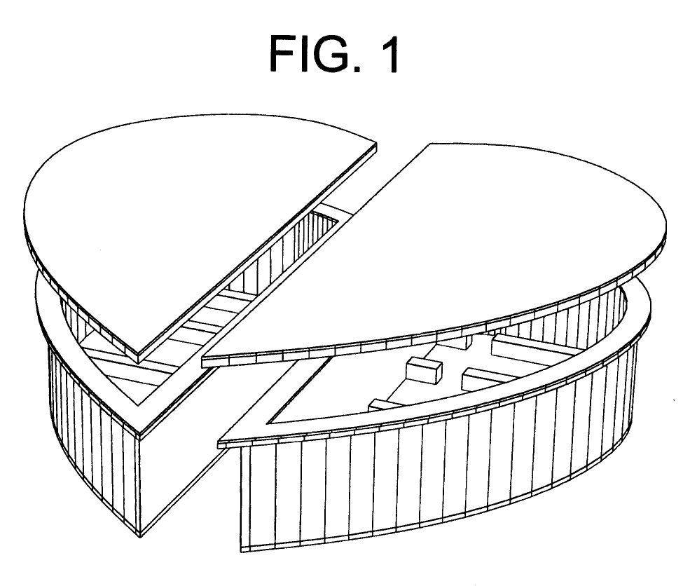

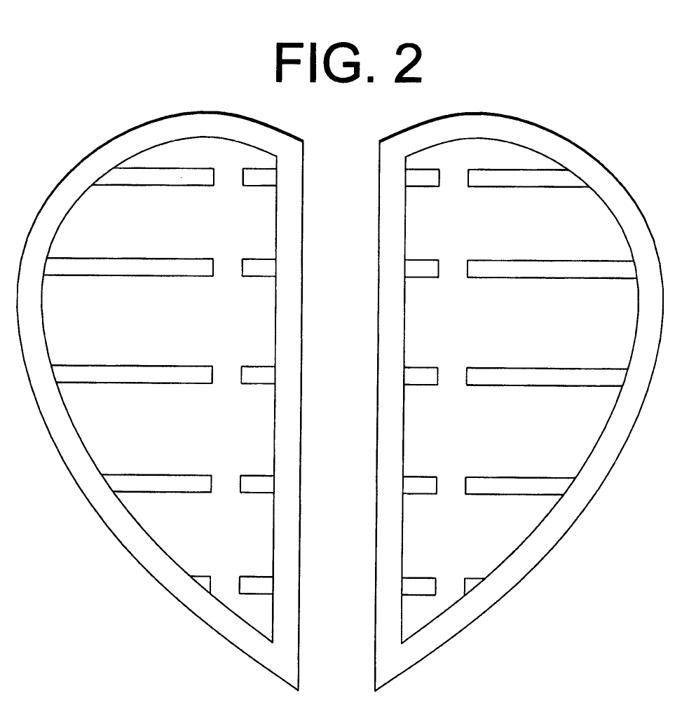

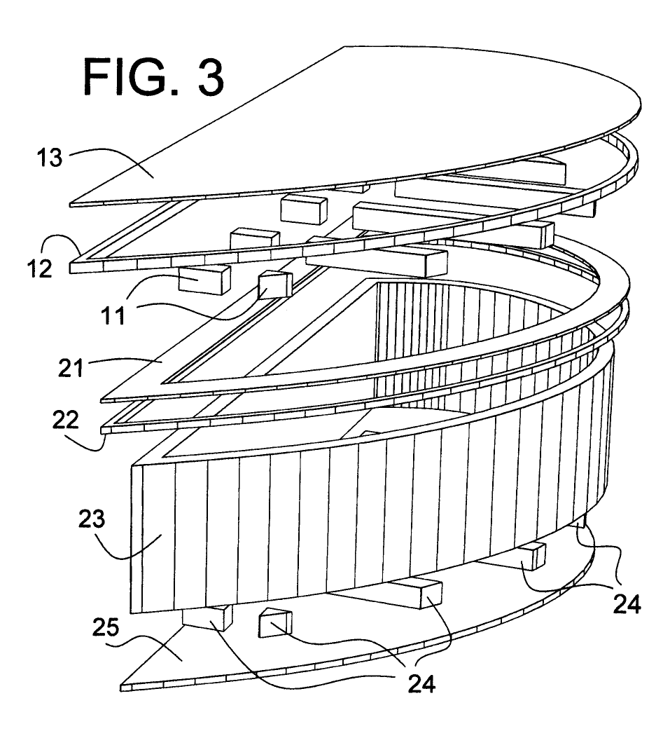

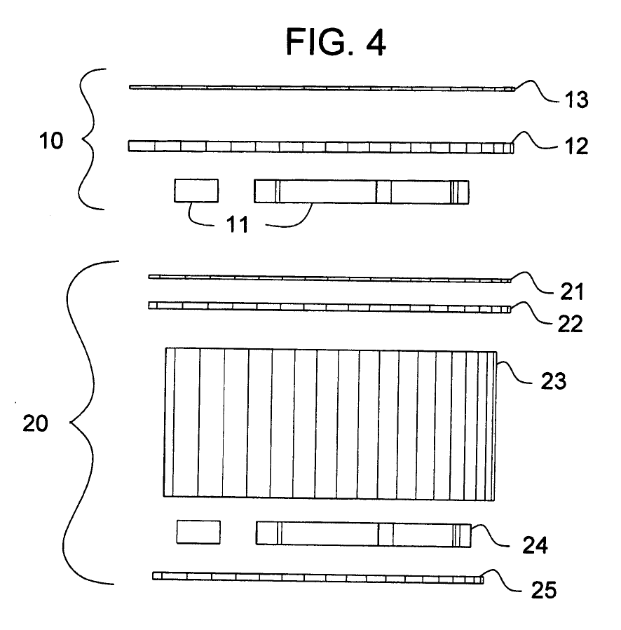

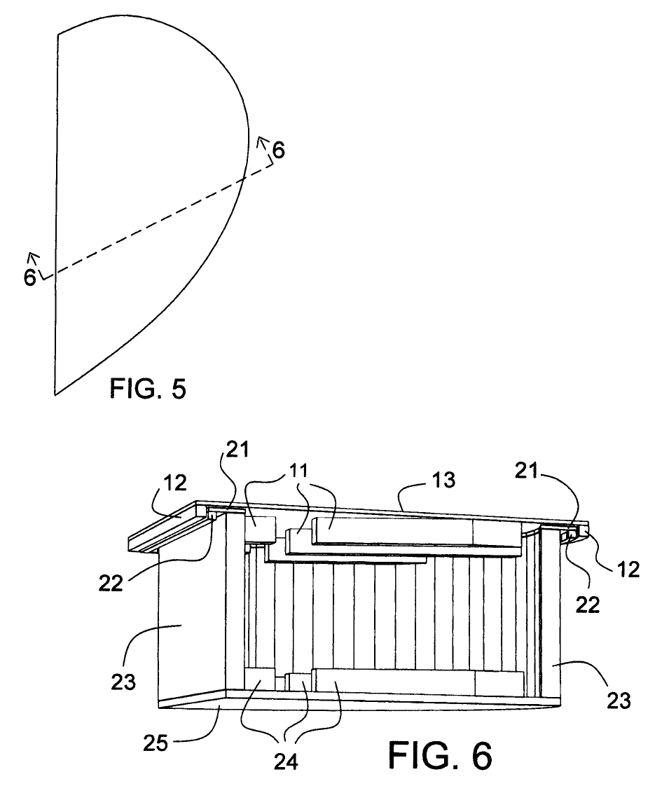

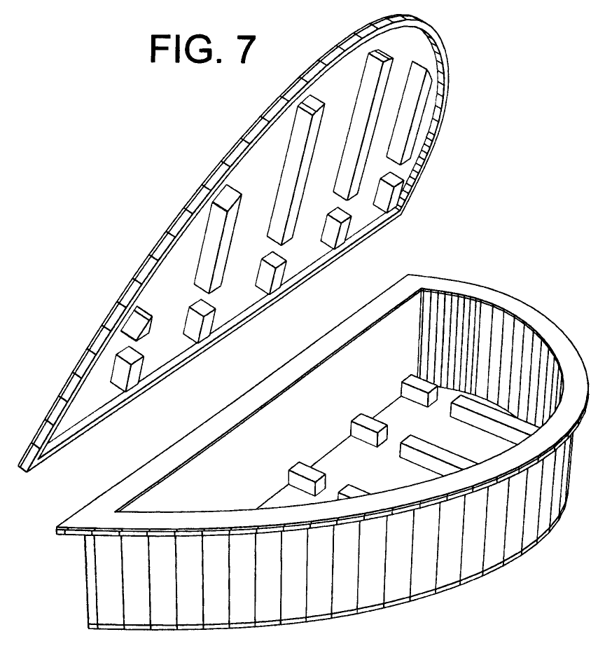

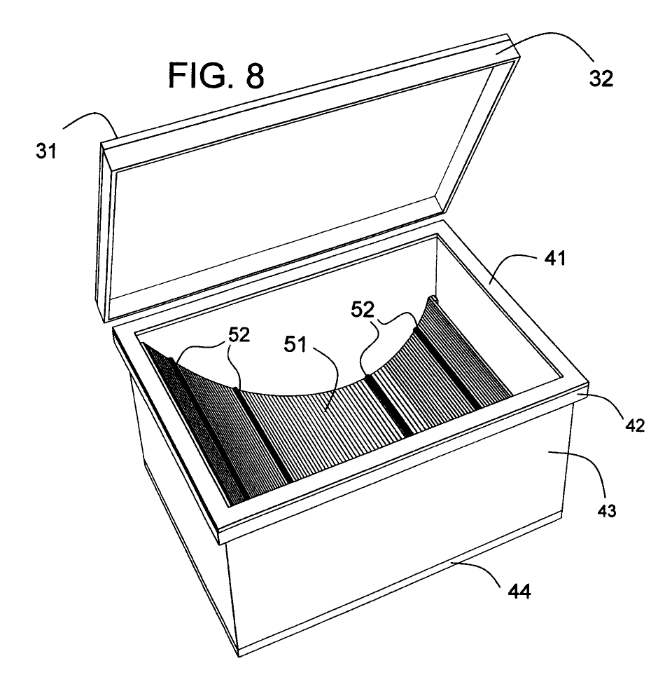

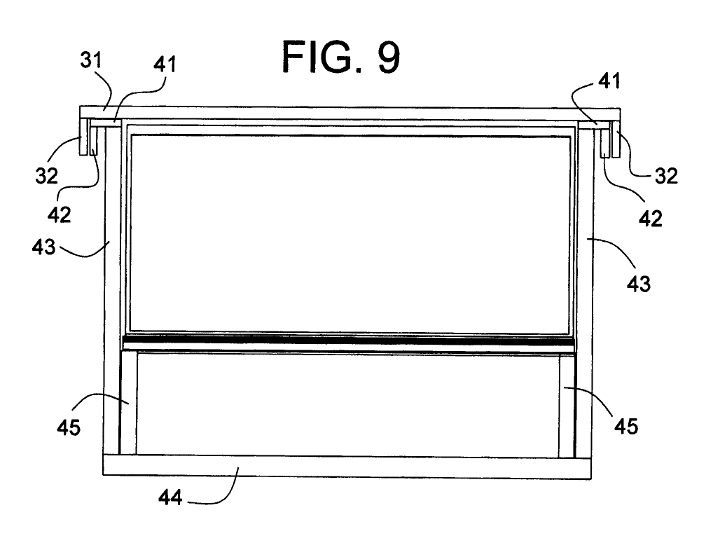

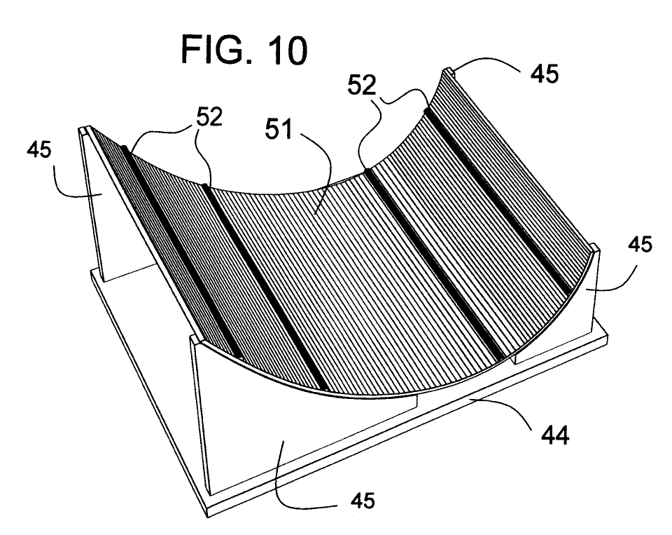

### REFERENCE NUMERALS IN DRAWINGS

The table below lists the reference numerals employed in the figures, and identifies the element designated by each numeral.
10 half heart cover assembly 10
11 upper support ribs 11 of half heart cover assembly
12 cover lip 12 of half heart cover assembly
13 cover 13 of half heart cover assembly
20 half heart enclosure assembly 20
21 upper support 21 of half heart enclosure assembly
22 upper support lip 22 of half heart enclosure assembly
23 vertical side wall 23 of half heart enclosure assembly
24 lower support ribs 24 of half heart enclosure assembly
25 bottom 25 of half heart enclosure assembly
30 rectangular cover assembly 30
31 cover 31 of rectangular cover assembly
32 cover lip 32 of rectangular cover assembly
40 rectangular enclosure assembly 40
41 upper support 41 of rectangular enclosure assembly
42 upper support lip 42 of rectangular enclosure assembly
43 vertical side wall 43 of rectangular enclosure assembly
44 bottom 44 of rectangular enclosure assembly
45 curved support members 45 of rectangular enclosure assembly
51 curved support base 51 of rectangular enclosure assembly
52 support base ribs 52 of rectangular enclosure assembly
60 heart shaped coffin 60

### DETAILED DESCRIPTION

One embodiment of a half heart shaped vault comprises half heart cover assembly 10 and half heart enclosure assembly 20. Half heart shaped assembly 10 has upper support ribs 11 that are affixed to the underside of cover 13 and cover lip 12 that is affixed to the underside of cover 13 approximate the outer periphery thereof.

Half heart shaped enclosure assembly 20 has bottom 25 and vertical side wall 23 that form essentially a half heart shape; upper support lip 22 is affixed to the underside of upper support 21; upper support 21 is affixed to the top of vertical side wall 23.

Upper support lip 22 and upper support 21 cooperatively fit with cover lip 12 and cover 13 when the cover assembly 10 is placed on top of the enclosure assembly 20. Lower support ribs 24 are affixed to the top of bottom 25.

In one embodiment, a plurality of upper and lower support ribs 11, 24 are used in the cover assembly 10 and enclosure assembly 20. They are displaced laterally with respect to a coffin placed within the vault. Their purpose is to hold the coffin in place.

Upper and lower support ribs 11, 24 are bifurcated into first and second portions to accommodate the protruding handles on the sides of a coffin being displaced between the first and second portions.

For an example of such handles, see U.S. application Ser. No. 12/430,882 of Antoine Elhaj, filed Apr. 27, 2009, entitled “Broken Heart Shaped Coffin” wherein the coffin in at least one embodiment comprises side handles.

One of skill in the art will appreciated that the handles will likely be on both sides of the coffin so the upper and lower support ribs should be bifurcated to form a space to coincide with the location of the handles which can be placed in varying arrangements.

One embodiment of a vault comprises rectangular cover assembly 30 and rectangular enclosure assembly 40. Rectangular cover assembly 30 comprises rectangular cover 31 and cover lip 32 attached to the underside of cover 31 essentially around the periphery thereof. Rectangular enclosure assembly 40 has upper support 41, upper support lip 42, vertical side wall (a.k.a. “wall”) 43, bottom 44, curved support members 45, curved support base 51, and support base ribs 52. Rectangular bottom 44 is attached to vertical side wall 43 essentially around the periphery thereof.

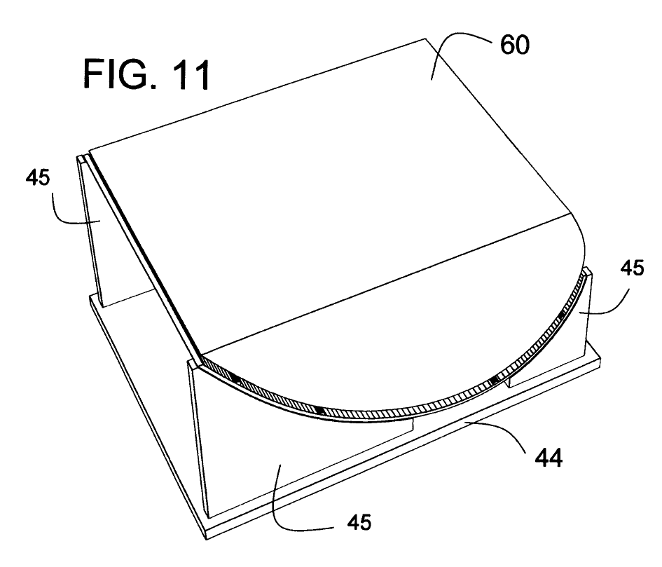

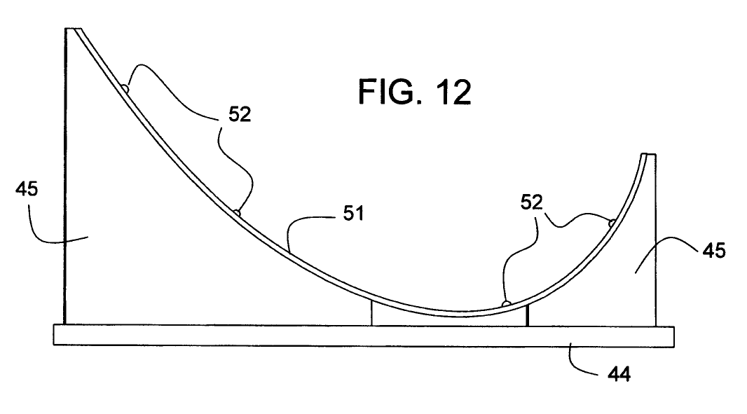

Curved support base 51 is adapted to hold a heart shaped coffin (FIG. 11). FIG. 11 depicts a heart shaped coffin generally. Four curved support members 45 are attached to bottom 44. They are adapted to support the curved support base vertically above the bottom.

Upper support 41 is attached to the top of the vertical side wall 43. Upper support lip 42 is attached to the underside of upper support 41 essentially around the periphery thereof. Upper support lip 42 and upper support 41 cooperatively fit with cover lip 32 and cover 31 when cover assembly 30 is placed on top of the enclosure assembly 40. Four support base ribs 52 are attached laterally across the curved support base whereby a heart shaped coffin can be vertically offset from the curved support base. This is further advantageous in that the vertical offset facilitates the removal of retaining straps that are commonly used to lower coffins into vaults.

What is claimed is:

1. A half heart shaped vault comprising:
a half heart shaped cover;
and a half heart shaped enclosure having a bottom having essentially a half heart shape and a vertical side wall attached to the bottom essentially around the periphery thereof.

2. A complementary pair of first and second half heart shaped vaults, the first vault comprising the half heart shaped vault of claim 1, the second vault being complementary to the first vault and a mirror image thereof.

3. The half heart shaped vault of claim 1 wherein:
the half heart shaped cover further comprises,
an upper support rib being affixed to the underside of the cover,
and a cover lip being affixed to the underside of the cover approximate the outer periphery thereof;
the half heart shaped enclosure further comprises,
an upper support lip being affixed to the underside of an upper support,
the upper support being affixed to the top of the vertical side wall,
and a lower support rib being affixed to the top of the bottom of the enclosure.

4. The half heart shaped vault of claim 3 wherein:
the upper and lower support ribs are bifurcated into first and second portions to accommodate the protruding handles on the sides of a coffin being displaced between the first and second portions when the coffin is placed within the vault.

5. A vault comprising:
a rectangular cover;
a rectangular enclosure assembly having,
a rectangular bottom and a vertical side wall attached to the bottom essentially around the periphery thereof,
a curved support base adapted to hold a heart shaped coffin,
four curved support members attached to the bottom and being adapted to support the curved support base vertically above the bottom.

6. The vault of claim 5 further comprising:
a cover lip attached to the underside of the cover essentially around the periphery thereof;
an upper support attached to the top of the vertical side wall;
an upper support lip attached to the underside of the upper support essentially around the periphery thereof;
and a plurality of support base ribs attached laterally across the curved support base whereby a heart shaped coffin can be vertically offset from the curved support base.
